(19) United States
(12) Patent Application Publication
(10) Pub. No.: US 2002/0055921 A1
(43) Pub. Date: May 9, 2002

(54) Multi-database system

(76) Inventors: Mitsuhiko Yoshimura, Yokohama (JP); Yuichi Yagawa, Yokohama (JP); Shigetoshi Hayashi, Fujisawa (JP); Norifumi Nishikawa, Machida (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/803,149

(22) Filed: Mar. 12, 2001

(30) Foreign Application Priority Data
Nov. 6, 2000 (JP) 2000-342373

(51) Int. Cl. G06F 7/00

(52) U.S. Cl. 707/9

(57) ABSTRACT

There is provided units for managing and defining a virtual table access privilege, an integration-target-DB access privilege, and access-privilege mapping information for making the connection between them. A processing unit for performing the access-privilege decision on the level of the virtual tables by using the definition contents of the information, and a processing unit for converting the virtual table access privilege into the integration-target-DB access privilege are provided. System structuring working on the AP (application) side and that on the integration-target DBMS side can be carried out easily in parallel to reduce the load imposed on the system structuring working.

### BACKGROUND OF THE INVENTION

The present invention relates to the access-privilege management in a multi-database integrating system in which databases exist dispersively.

As a prior art, a multi-database integrating system for integrating (unifying) a plurality of database management systems (hereinafter simply referred to as “DBMSs”) has hitherto been known.

For example, JP-A-8-16439 describes “Apparatus and Method of Sharing Data between Different Database Systems”. By taking advantage of this type of multi-database integrating system, an application (hereinafter simply referred to as “AP”) utilizing a plurality of DMBSs can be developed with ease. Select (retrieval) results can be acquired from the plurality of DBMSs by applying select (retrieval) processing to only the multi-database integrating system. In this type of multi-database integrating system, the access to the plural databases to be integrated (integration-target databases) must be controlled in order to obtain actual data from the plural integration-target databases.

In the conventional multi-database integrating system, in order to control the connection to the integration-target databases and the access to tables, the user names in the multi-database integrating system are converted into the user names in the integration-target databases. In this phase, in order to decide whether or the access privilege to the multi-database integrating system is valid, it is decided whether or not the converted user names are accessible by the respective integration-target DBMSs. The SQL/MED standards of database language SQL prescribed by the ISO (International Standardization Organization) describe the mapping definition for making the connection of the user names in the multi-database integrating system with the user names in the integration-target databases.

In structuring a system, the managing organization on the side of the AP structured on the multi-database integrating system sometimes differs from that on the integration-target DBMS side. In such a case, for the sake of connecting the AP to the integration-target DBMSs, it is desirable to proceed with the system structuring working on the AP side independently of that on the integration-target DBMS side. However, in the conventional system, since the direct connection of the user names in the multi-database integrating system with the user names in the integration-target DBMSs is made, the access-privilege definitions complying with utilization forms on the AP side cannot be effected unless the access privileges to the integration-target users/integration-target DBMSs can be defined. For this reason, the system structuring working on the AP side cannot be proceeded with independently of that on the integration-target DBMS side, so that efficient system development can hardly be attained.

Further, in the conventional access-privilege managing method, it sometimes becomes complicated to perform the setting operation for distinguishing the users on the AP side using the log information on the integration-target DBMS side. For example, in order to perform the setting operation for distinguishing “a user who utilizes the integration-target DBMSs from the AP in the same organization through the multi-database integrating system” from “a user who utilizes the integration-target DBMSs from the AP in a different organization through the multi-database integrating system”, the user design on the AP side must be conducted simultaneously with that on the integration-target DBMS side. Because of such troublesome working as above, the aforementioned setting operation for distinction is not carried out and accordingly, in the event that a trouble of security takes place on the side of the integration-target DB, the users to be searched cannot sometimes be sorted into groups.

When the managing organization on the side of the AP structured on the multi-database integrating system differs from that on the integration-target DBMS side, the change of the table-operating rights or the delete of the user names per se is done in respect of the user names on the integration-target DBMSs without informing the AP users of this fact. The prior art, however, lacks means for detecting and restoring the mismatch taking place in such an event.

### SUMMARY OF THE INVENTION

An object of the present invention is to provide an access-privilege managing method which can proceed with system structuring on the AP side independently of that on the integration-target DBMS side, in a multi-database integrating system.

In order to accomplish the above object, the present invention is constituted as below. Namely, according to the present invention, the access to the integrated data, which is access operation for accessing to the dispersed data as the actual situation, is controlled based on an access privilege to dispersed data containing real tables and an access privilege to integrated data containing virtual tables constituted by the real tables.

### BRIEF DESCRIPTION OF THE DRAWINGS

FIG. 1 is a diagram showing an outline of the processing procedure in a first embodiment according to the invention.

FIG. 2 is a diagram showing the construction of a system in the first embodiment.

FIG. 3 is a diagram showing the construction of tables in the first embodiment.

FIG. 4 is a diagram showing access-privilege mapping set up in a unit of virtual table.

FIG. 5 is a diagram showing access-privilege mapping set up in a unit of user.

FIG. 6 is a diagram showing access-privilege mapping set up in a unit of DBMS.

FIG. 7 is a flow chart of processing in a definition unit.

FIG. 8 is a flow chart of processing in a multi-database integrating unit.

FIG. 9 is a flow chart of processing in access-privilege mapping definition.

FIG. 10 is a flow chart of matching check in access-privilege mapping during definition.

FIG. 11 is a flow chart of matching check in access-privilege mapping during execution.

FIG. 12 is a flow chart of virtual-table-access-privilege decision.

FIG. 13 is a flow chart of access-privilege conversion.

FIG. 14 shows an example of a picture illustrative of access-privilege mapping definition.

FIG. 15 is a diagram showing an outline of a second embodiment according to the invention.

FIG. 16 shows an example of a picture for corresponding an access privilege.

FIG. 17 is a diagram showing the construction of a system in which a DBMS per se is integrated with other DBMSs.

FIG. 18 is a diagram showing the construction of a system in which a definition tool manages a plurality of DB integrating systems.

### DESCRIPTION OF THE EMBODIMENTS

Firstly, the first embodiment of the invention will be outlined. The present embodiment comprises a definition unit for defining definition information for a multi-database integrating unit, a definition DB for storing the definition information of the definition unit, and the multi-database integrating unit for integrating a plurality of databases.

The definition unit includes an access privilege mapping definition unit, and a matching check unit for access privilege mapping during definition. The access privilege mapping definition unit makes the connection between access privileges to virtual tables (virtual table access privileges) managed on the multi-database integrating unit and access privileges to real tables (real table access privilege) on integration-target DBMSs, and performs processing of saving the connection relation. On the basis of the connection relation defined as above, the matching check unit for access privilege mapping during definition makes a decision as to whether or not any mismatching takes place between the access privilege to the virtual table and the access privilege to the real table. When detecting a mismatch, the matching check unit informs a user in charge of the definition processing to support the restoration of the mismatching.

The definition DB holds DBMS information, user information, virtual table definition, virtual table access privilege, and access privilege mapping. Regarding the DBMS information, management information for the integration-target DMBSs is held.

Regarding the user information, virtual table users are managed. Regarding the virtual table definition, the definitions of the virtual tables are stored. Regarding the virtual table access privilege, the access privileges to the virtual tables are managed. Regarding the access privilege mapping, the connection relation between the virtual table access privileges and the access privileges to the integration-target DBMSs is held.

The multi-database integrating unit includes a matching check unit for access privilege mapping during execution, a virtual table access privilege deciding unit, and an access privilege conversion unit. The matching check unit for access privilege mapping during execution detects whether or not any mismatching takes place in the defined access privilege mapping in an environment during execution. When detecting a mismatch, the matching check unit performs the restoration processing within a possible range. The virtual table access privilege decision unit decides the access privilege to the virtual table utilized on the AP side. The access privilege conversion unit converts the virtual table access privilege into the access privilege to a DBMS which becomes the integration target.

An access privilege controlling system of the present embodiment is a system for implementing the access privilege control to the virtual tables in the multi-database integrating system. The multi-database integrating system referred to herein is a system which combines tables stored in a plurality of database management systems to define a single table called a virtual table, and performs the inquiry processing of select, update, delete or insert of record information by a system user using the operation language for the DBMS such as SQL to the virtual table. The inquiry processing includes at least one of the insert, select, change and copy of the record information. The change includes at least one of the update, substitution and delete of the integrated data and the data addition to the dispersed data. Besides the record information, the above processing to the whole of virtual tables and real tables may be involved.

In the conventional DBMS, there is concept called “view” for virtually combining a table storing real data with a plurality of tables. The virtual table in the multi-database system is defined as a “view” applied to tables on different DBMSs. Further, in the multi-database system, the connection between the virtual table and users having the operation right to the virtual table or the kinds of table-operation rights is made as in the conventional DBMS to manage the access privilege information for the virtual table. The access privilege information referred to herein is information which is created by the DBMS or multi-data system user and shows the connection indicating which SQL operation type (select, update, delete or insert) can undertake in relation to the table, the view and the virtual table.

Especially, the access privilege information to the virtual table is called a “virtual table access privilege”. Then, the access privilege to the table and the “view” on the integration-target DBMS is called a “DBMS access privilege”.

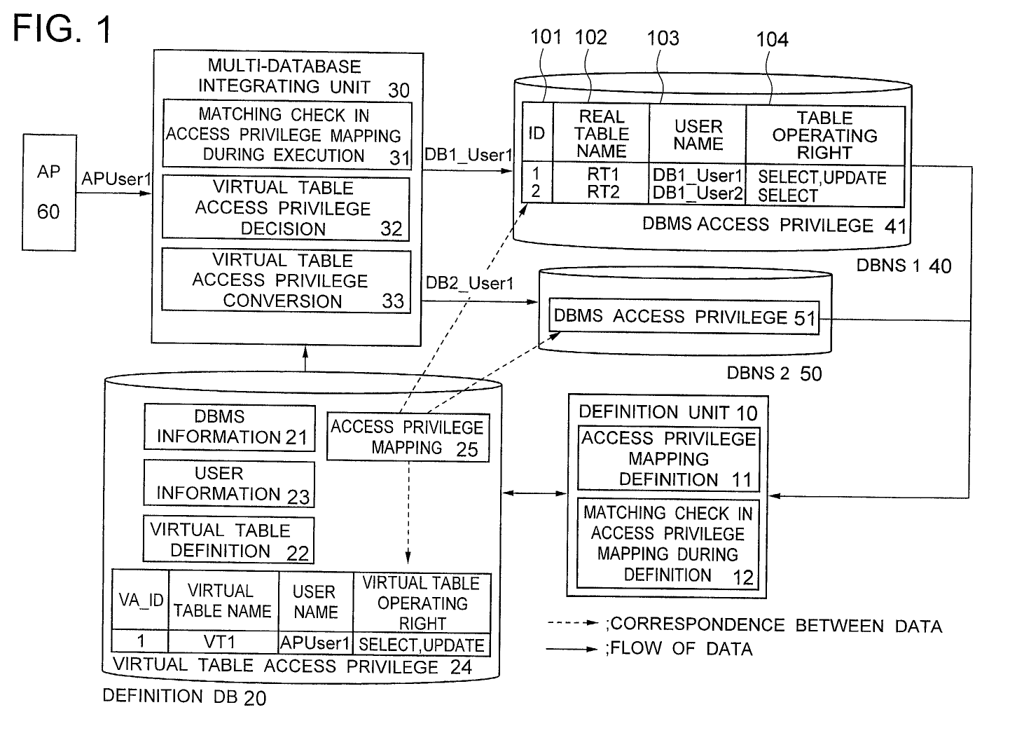

An outline of operation of the multi-database integrating system according to the first embodiment will now be described with reference to FIG. 1.

A definition unit 10 shown in FIG. 1 registers definition information such as access privilege mapping 25 to a definition DB 20. In registering, the access privilege mapping 25 is checked for mismatching.

In a multi-database integrating unit 30 shown in FIG. 1, a database integrating processing during execution is carried out. An AP 60 shown in FIG. 1 is an application utilizing a virtual table. In order for the AP 60 to apply an operation for the virtual table to the multi-database integrating unit 30, a log-in processing using a user name and a password is first executed. In FIG. 1, a connection processing is conducted between the AP 60 and the multi-database integrating unit 30 by using user name “APUser1”. In the multi-database integrating unit 30, it is confirmed whether or not the user name “APUser1” and the password exist in the user information 22 of the definition DB 20. When the user in question is present in the user information 22, the multi-database integrating unit 30 establishes the connection between the AP 60 and the multi-database integrating unit 30.

After the above connection has been established, the AP 60 makes a request to the multi-database integrating unit 30 for a table operating processing applied to the virtual table. The table operating processing can be requested using the SQL that is the typical DBMS operation language. For example, “SELECT * FROM VT1” is requested as the SQL applied to a virtual table VT1. The database integrating unit 30 receiving the SQL from the AP 60 causes a virtual table access privilege decision 32 to decide whether or not a SELECT operating right for the virtual table VT1 is given to “APUser1”. For the processing of deciding the access privilege to the virtual table, a virtual table access privilege 24 in the definition DB 20 is used. In the virtual table access privilege 24 shown in FIG. 1, the SELECT and UPDATE rights of “APUser1” for the VT1 is defined, so that it is determined that for the aforementioned SQL, the virtual table access privilege is valid.

In case the virtual table access privilege is successfully concluded, the connection establishment between the multi-database integrating unit 30 and the integration-target DBMSs must be effected as a preprocessing of acquiring the real data for constituting the virtual table from the integration-target DBMSs. In FIG. 1, the integration-target DBMSs are DBMS1 (40) and DBMS2 (50). Now, it is to be noted that the user name and the password necessary for the connection between the multi-database integrating unit 30 and the integration-target DBMSs are different from the user name “APUser1” used for setting up the connection between the AP 60 and the multi-database integrating unit 30. By carrying out a processing of converting the virtual table access privilege into the access privilege to the integration-target DBMSs in virtual table access privilege conversion 33, a user name necessary for the connection between the multi-database integrating unit 30 and the integration-target DBMSs can be acquired. In performing the virtual table access privilege conversion 33, the access privilege mapping 25 on the definition DB 20 is referred.

After the user names necessary for the DBMS connection have been acquired by means of the virtual table access privilege conversion 33, the connection between the multi-database integrating unit 30 and the integration-target DBMSs is established. Then, the multi-database integrating unit 30 applies a table operating processing such as select processing to the individual integration-target DBMSS, and the results obtained from the respective integration-target DBMSs are integrated (or unified) on the multi-database system side to respond to the application side.

The outline of operation of the multi-database integrating unit 30 is as above.

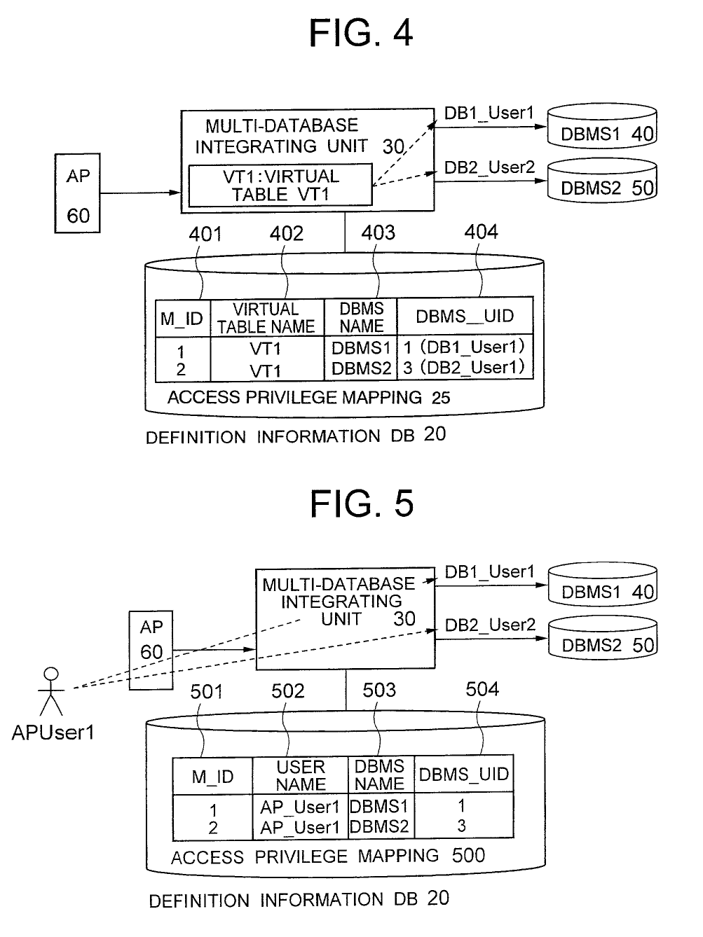

Especially, the present invention is concerned with the access privilege control in the above processing procedure. Especially, in the invention, the following three schemes are described as the access privilege conversion. These schemes are constructed as shown in FIGS. 4, 5 and 6.

(1) A scheme of making the connection of the user names on the integration-target DBMSs to a unit of virtual table: In an example shown in FIG. 4, user names “DB1_User1” and “DB2_User1” on the integration-target DBMSs are caused to correspond to the virtual table VT1.

(2) A scheme of making the connection of the user names on the integration-target DBMSs in a unit of user of the multi-database: In an example shown in FIG. 5, user names “DB1_User1” and “DB2_User1” on the integration-target DBMSs are caused to correspond to the user “APUser1” of the multi-database system.

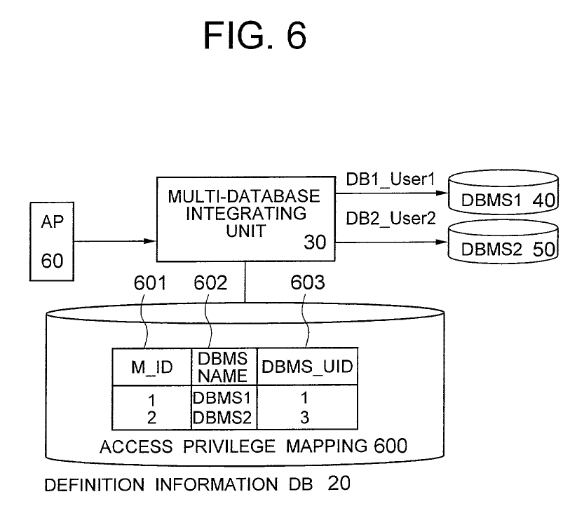

(3) A scheme of making the connection of a fixed user name in a unit of integration-target DBMS: In an example shown in FIG. 6, the connection of fixed user names “DB1_User1” and “DB2_User1” is made in a unit of integration-target DBMS.

In the following, the first embodiment based on scheme (1) above will first be described. By making reference to FIG. 1 used for outline description, a description will be given in greater detail. As shown in FIG. 1, the processing block diagram of the first embodiment illustrates the definition unit 10, the definition DB 20, the multi-database integrating unit 30, the DBMS1 40, the DBMS2 50, and the AP 60.

In the definition unit 10, a series of definition information used in the multi-database integrating unit 30 is registered/corrected. Results of the registration/correction in the definition unit 10 are saved in the definition DB 20. The definition unit 10 includes the access privilege mapping definition 11, and a matching check 12 in the access privilege mapping during definition. The access privilege mapping definition 11 makes the connection between the virtual table access privilege managed on the multi-database integrating unit and the DBMS access privilege on the integration-target DBMSS, and performs a processing of saving the connection relation. The matching check 12 in the access privilege mapping during definition decides whether or not any mismatching takes place in mapping between the access privilege to the virtual table and the access privilege to the real table. Then, the matching check 12 informs the user of the mapping suffering from the mismatch by displaying a picture in a form which differs from the normal one. An example of the picture is depicted in FIG. 14.

In the multi-database integrating unit 30, the definition information saved in the definition DB 20 is used to perform a processing of integrating data of the DBMS1 (40) and DBMS2 (50). The multi-database integrating unit 30 includes the matching check 31 in the access privilege mapping during execution, the virtual table access privilege decision 32, and the virtual table access privilege conversion 33. In the matching check 31 in the access privilege mapping during execution, it is detected whether or not the access privilege mapping defined in an environment during execution suffers from any mismatching. Then, when a mismatch is detected, a restoring processing based on a predetermined rule is carried out. In the virtual table access privilege decision 32, the access privilege decision to the virtual table utilized on the AP side is carried out. In the virtual table access privilege conversion 33, a processing of converting the virtual table access privilege into the access privilege to the DBMS representing the integration-target is carried out. When the AP 60 makes a request to the multi-database integrating unit 30 for table operation applied to the virtual table, the multi-database integrating unit 30 converts the request for the virtual table into a table operation request to the DBMS1 (40) and DBMS2 (50). For the table operation request from the AP 60 to the multi-database integrating unit 30, the SQL standing for the standard language of database operation is used. The SQL is also used for operation from the multi-database integrating unit 30 to the DBMS1 (40) and DBMS2 (50).

The DBMS1 (40) and DBMS2 (50) are the DBMSs to be integrated, that is, the integration-target DBMSs. While the access privilege information for the virtual table is stored on the definition DB as the virtual table access privilege 24, the access privilege to the real table which is stored on the coordinative DBMS is stored on the integration-target DBMS as a DBMS access privilege 41 shown in FIG. 1. The DBMS access privilege 41 includes an ID 101, a real table name 102, a user name 103, and a table operating right 104. From the standpoint of packaging level, details of the integration-target DB access privilege 41 differ DBMS by DBMS, but any DBMS manages, as internal information, an item similar to the DBMS access privilege 41. Accordingly, for simplicity of explanation, the present embodiment will be described on the assumption that the access privilege to the real table is managed on any DBMS by the structure of the integration-target DB access privilege 41. Practically, the management may be effected using a table and file of a form different from that of the DBMS access privilege 41.

Definition information for controlling the multi-database integrating unit 30 is stored in the definition DB 20. The definition DB 20 holds DBMS information 21, user information 22, virtual table definition 23, a virtual table access privilege 24, and access privilege mapping 25. The DBMS information 21 holds management information for the integration-target DBMSs. The user information 22 manages the virtual table users. The virtual table definition 23 stores definitions of the virtual tables. The virtual table access privilege 24 manages the access privileges to the virtual tables. The access privilege mapping 25 holds the connection relation between the virtual table access privileges and the integration-target DBMS access privileges. In the first embodiment, the access privilege mapping 25 as detailed in FIG. 4 is used.

The explanation of the block diagram of the first embodiment is now over.

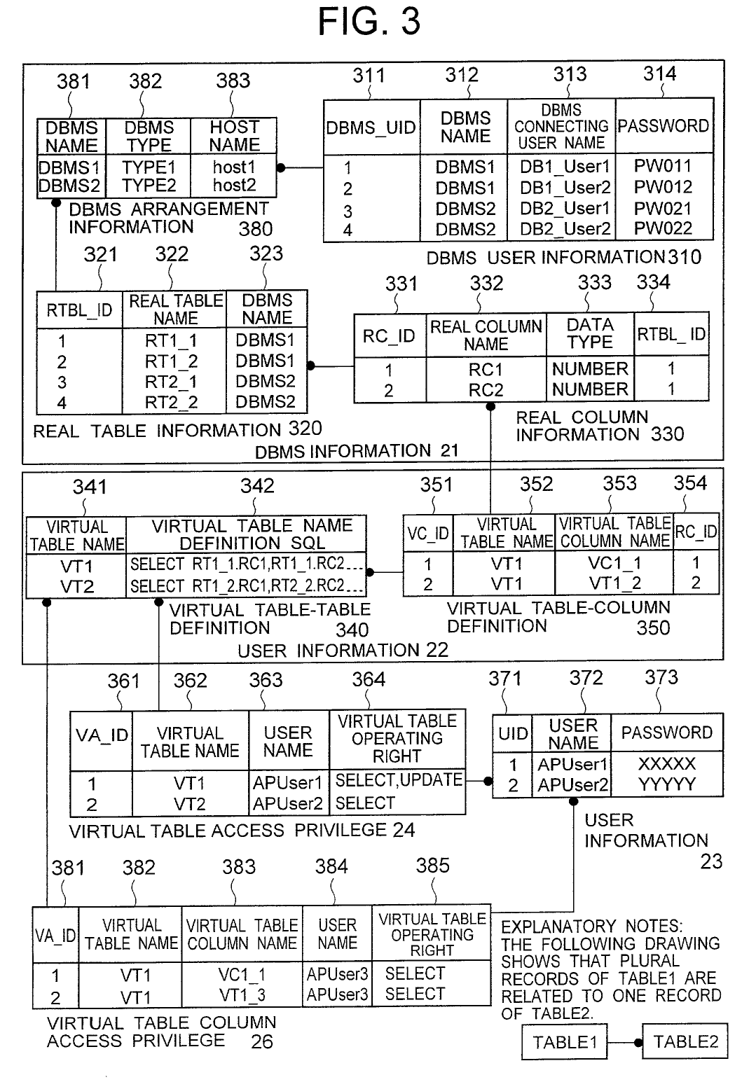

In the following, the individual information stored in the definition DB 20 of FIG. 1 will be detailed with reference to FIG. 3.

The DBMS information 21 is for storing information necessary to manage the DBMSs to be integrated. As shown in FIG. 3, it includes four tables of DBMS arrangement information 380, DBMS user information 310, real table information 320, and real column information 330.

The DBMS arrangement information 380 of FIG. 3 consists of DBMS name 381, DBMS type 382, and a host name 383. The names of the DBMSs to be integrated are stored in the DBMS name 381. The types of the DBMSs are stored in the DBMS type 382. For example, the product names of the DBMSs are stored. Host names indicative of computers in which the DBMSs are arranged are stored in the host name 383.

The DBMS user information 310 of FIG. 3 consists of DBMS_UID 311, DBMS name 312, DB connecting user name 313, and password 314. Identification values for definitely identifying records of the DBMS user information 310 are stored in the DBMS_UID 311. Values corresponding to the DBMS name 381 are stored in the DBMS name 312. User names and passwords for accessing DBMSs to be integrated are stored in the DBMS connecting user name 313 and the password 314.

The real table information 320 of FIG. 3 includes RTBL_ID 321, real table name 322, and DBMS name 323. Identification values for definitely identifying records of the real table information 320 are stored in the RTBL_ID 321. Names of the real tables that exist on the DBMSs are stored in the real table name 322. Corresponding values among values stored in the DBMS name 382 of DBMS arrangement information 380 are stored in the DBMS name 323.

The real column information 330 of FIG. 3 includes RC_ID 331, real column name 332, data type 333, and RTBL_ID 334. Identification values for definitely identifying records of the real column information 330 are stored in the RC_ID 331. Column names of the real tables are stored in the real column 332. Data types in the real tables in the real column name 332 are stored in the data type 333. Values of the RTBL_ID 321 on the real table information 320 which correspond to the real table names holding the real column name 332 are stored in the RTLL_ID 334.

The virtual table definition 22 of FIG. 1 includes two tables, i.e., virtual table-table definition 340 and virtual table-column definition 350, as shown in FIG. 3.

The virtual table-table definition 340 of FIG. 3 stores information for defining the virtual tables. The virtual-table definition 340 consists of virtual table name 341, and virtual table name definition SQL 342. Virtual table names are stored in the virtual table name 341. SQL statements for defining the virtual tables are stored in the virtual table name definition SQL 342. Tables on DBMSs to be integrated are used as targets in describing the SQL statements. To define the virtual table, other methods than the method using the SQL may be employed.

The virtual table-column definition information 350 of FIG. 3 stores information for managing items on the virtual tables. The virtual table-column definition information 350 consists of VC_ID 351, virtual table name 352, virtual table column name 353, and RC_ID 354. Identification values for definitely identifying records of the virtual table-column definition information 350 are stored in the VC_ID 351. Corresponding values among values in the virtual table name 341 are stored in the virtual table name 352. Column names of the virtual tables are stored in the virtual table column name 353. The RC_ID 354 stores values of RC_ID 331 in the real column information 330 as identifiers of real columns corresponding to virtual table columns.

The user information 23 of FIG. 1 is for managing the user names and the passwords for the virtual tables. As shown at user information 23 in FIG. 3, the user information 23 includes UID 371 for definitely identifying records of the user information 23, user name 372, and password 373.

The virtual table access privilege 24 of FIG. 1 includes VA_ID 361, virtual table name 362, user name 363, and virtual table operating right 364 as shown in FIG. 3. Identification values for definitely identifying records of the virtual table access privilege 24 are stored in the VA_ID 361. Virtual table names which are the targets of the access privilege connection are stored in the virtual table mane 362. Of the virtual table names stored in the virtual table name 341 in the virtual table-table definition 340, those concerned are stored in the virtual table name 362. Of the user name 372 stored in the user information 23, those to which the access privileges to the virtual tables are made to correspond are stored in the user name 363. The virtual table operating right 364 stores values for indicating which one of the SQL operation types for the virtual tables, that is, SELECT, DELETE, UPDATE, and INSERT is permissible. In the example of FIG. 3, it is indicated that for the virtual table VT1, the user “APUser1” is permitted to operate SELECT and UPDATE.

As described previously, the access privilege mapping information 25 is for making the connection between the access privilege defined for the virtual table and the access privilege defined on the DBMS to be integrates. The access privilege mapping information 25 in the first embodiment is shown in FIG. 4. The access privilege mapping information 25 consists of M_ID 401, virtual table name 402, DBMS name 403, and DBMS_UID 404. Values for definitely identifying records in the access privilege mapping information 25 are stored in the M_ID 401. Corresponding values of values in the virtual table name 341 of FIG. 3 are stored in the virtual table name 402. Corresponding values of the DBMS name 381 are stored in the DBMS name 403. Values of corresponding DBMS_UID are stored in the DBMS_UID 404.

The DBMS user name can be acquired from the DBMS_UID by making reference to the DBMS user information 310. As a result, by using the access privilege mapping information 25 for the DBMS, the connection of the virtual table and the user name of the integration-target DBMS can be made. The access privilege information including the user name is managed on the integration-target DBMS. As a result, the access privilege mapping information 25 makes the connection between the virtual table access privilege 24 and the DBMS access privileges 41 and 51. This relation is shown in FIGS. 1 and 4.

The table schema on the definition DB 20 in the present invention is in no way limited to that shown in FIGS. 3 and 4. A table schema may be defined in a different form, provided that information comparable to that in FIGS. 3 and 4 can be managed. Without using the DBMS, the definition DB 20 can be realized in the form of a file system of unique design format.

In the above embodiment, setting of the access privileges in a unit of table by using the virtual table access privilege 24 shown in FIG. 3 has been described. Alternatively, however, the access privileges can be set in a unit of column in the virtual table by means of the virtual table column access privilege 26, as shown in FIG. 3. The virtual table column access privilege 26 consists of VAC_ID 381 and virtual table name 382 for specifying virtual tables, virtual table column name 383 for setting access privileges, user name 384 given access privileges, and virtual table operating right 385 indicating the contents of the access privileges. With the virtual table column access privilege 26 provided, the access privilege can be set in a unit of column within a virtual table in which a plurality of DBMSs are integrated in a unit of table as in the case of the foregoing embodiment. But, in the case of a virtual table in which a plurality of DBMSs are integrated in a unit of column, the access privilege must be set in a unit of column by the virtual table column access privilege 26 shown in FIG. 3.

It will be appreciated that both the virtual table access privilege 24 and the virtual table column access privilege 26 can be used at the same time. In case both the virtual table access privilege 24 and the virtual table column access privilege 26 are set to the same virtual table, the access privilege decision process is carried out on the assumption that the access privileges in a unit of table have been set.

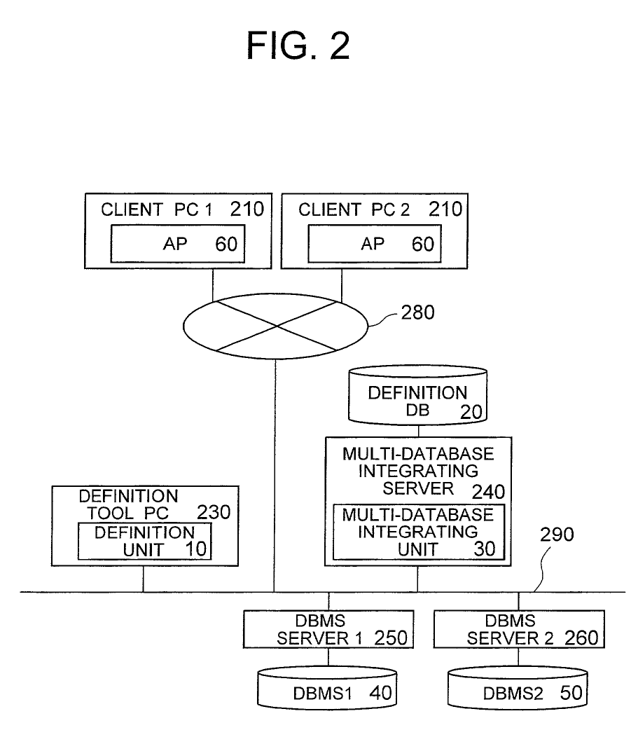

Referring to FIG. 2, the construction of the system in the first embodiment will be described. The system according to the present embodiment comprises a client PC1 210, a client PC2 220, a definition tool PC 230, a multi-database integrating server 240, a DBMS server 1 250, a DBMS server 2 260, a wide-area network 280, and a network 290. The client PC1 210, client PC2 220, definition tool PC 230, multi-database integrating server 240, DBMS server 1 250, and DBMS server 2 260 constitute a computer apparatus. Each of them has CPU, memories, storage devices, a keyboard, and a mouse, as an usual computer apparatus. Individual processing sections are arranged as shown in FIG. 2. However, this arrangement is not limitative. All of processing operations may be carried out on a single computer apparatus. In FIG. 2, only two kinds of DBMSs are illustrated, but one or more desired DBMSs may be targeted. In FIG. 2, the network system is constructed for illustration purpose only and may be constructed as desired.

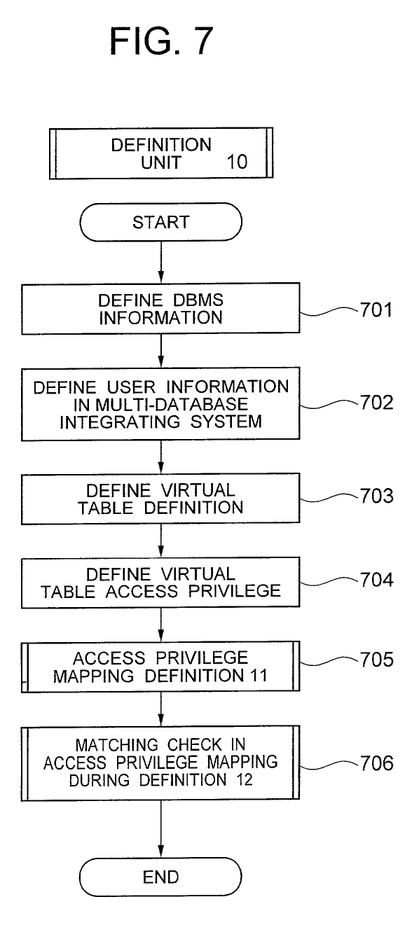

In the following, operation of the processing blocks in the first embodiment of FIG. 1 will be described with reference to FIGS. 7 to 13.

The process flow in the definition unit 10 will be described with reference to FIG. 7.

In step 701, the DBMS information 21 is defined using an input form. For construction of the input form, the individual tables in the DBMS information 21 shown in FIG. 3 are used for display without alteration.

In step 702, the user information 22 is defined using an input form. For construction of the input form, the individual tables in the user information 22 shown in FIG. 3 are used for display without alteration.

In step 703, the virtual table definition 23 is defined using an input form. For construction of the input form, the individual tables in the virtual table definition 23 as shown in FIG. 3 are used for display without alteration.

In step 704, the virtual table access privilege 24 is defined using an input form. For construction of the input form, the individual tables in the virtual table access privilege 24 shown in FIG. 3 are used for display without alteration.

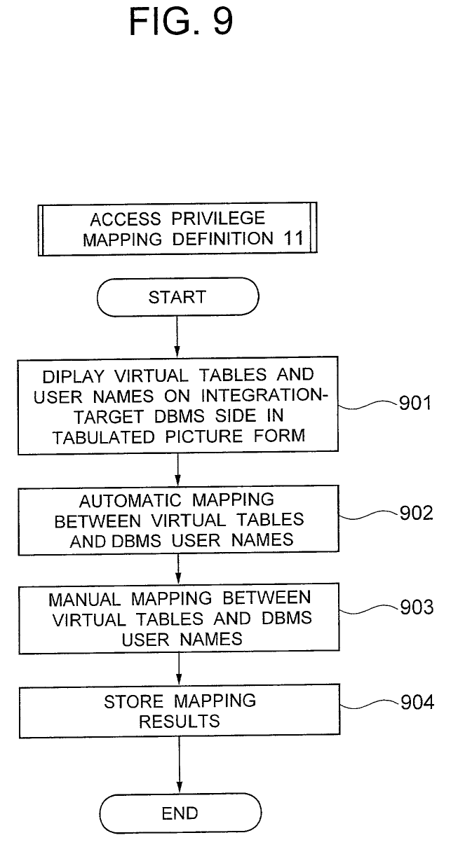

In step 705, the access privilege mapping definition 11 of FIG. 1 is carried out. Through this process, the access privilege mapping definition 25 on the definition DB 20 is defined. In the present step, an input form shown in FIG. 14 is used. Details will be described later by using FIG. 9.

In step 706, the matching check 12 in access privilege mapping during definition of FIG. 1 is carried out.

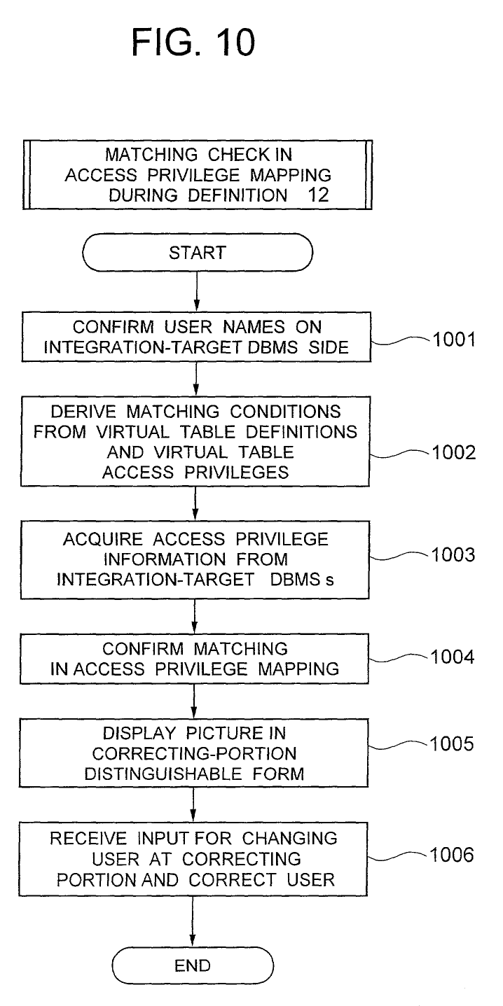

Through present process, it is checked whether or not any mismatch occurs between the access privilege mapping 25 and the information related thereto. Specifically, examinations as to “(1) whether or not the user on the DBMS user information 310 exists on actual integration-target DBMSs” and “(2) whether or not discrepancy exists between the virtual table operating right and the real table operating right” are conducted. Details will be described later with reference to FIG. 10.

The input forms used in the definition unit 10 are not limited to pictures displaying the table construction described in the above steps without alteration. But, any picture construction may be employed, provided that items indicative of input targets in the individual steps can be displayed. Further, for simplification of explanation, the process flow in the definition unit 10 of FIG. 7 is so described that necessary information is inputted to the definition DB step by step, but this is not limitative. For example, the process flow construction of event-driven type may be adopted in which a list of table names on the definition DB to be inputted are displayed in menus in a main picture and by selecting a menu, an individual picture necessary for performing input to the individual tables on the definition DB is displayed and return to the main picture is carried out after the input process to the individual tables ends.

Referring now to FIG. 9, the process flow in the access privilege mapping definition 11 will be described.

In step 901, a list of the virtual table names and a list of the user names on the integration-target DBMS side are acquired by referring the virtual table-table definition 340 and the DBMS user information 310 to display the lists on an input form. An example of GUI is shown in FIG. 14. In the GUI, the list of the virtual table names is indicated on ordinate and the list of the user names on the DBMS side is indicated on abscissa.

In step 902, the connection between the virtual table names and the integration-target DBMSs is inputted automatically.

In the example of FIG. 14, when the user selects menu item “automatic mapping 1402” by means of, for example, a mouse, it is decided whether or not the inclusive relation of name character string stands between the virtual table name and the user name. If the inclusive relation is valid, a circular sign is displayed in a cell part of the corresponding portion. In FIG. 14, since DB1_User1 representing the user name is included as a character string in virtual table name “DB1_User1 VT3”, a circular sign indicative of a result of automatic mapping is displayed as shown at a cell 1403. Generally, no clear relation stands between the virtual table name and the user name. Assumptively, however, the names of the virtual tables can be designed in accordance with a specified rule when the virtual table definition is carried out. In case the virtual table names are defined in accordance with such a specified rule as above, the automatic mapping process in the present step can alleviate working of the mapping definition by manual input. The rule will be outlined as below. The rule for automatic mapping is not limited to that described herein.

In step 903, the connection between the virtual table name and the integration-target DBMSs is inputted manually. In the illustrated example, by clicking using a mouse a cell at a portion for which the connection is desired, a circle is displayed in the cell. In the steps 902 and 903, the connection between the virtual table name and the integration-target DBMSs can be made by displaying circles in cells on the picture of FIG. 14.

In step 904, the user selects menu item “registration 1401” by means of the mouse to conduct a storing processing of the access privilege mapping information 25.

The mapping relation at the portion(s) where the circle(s) is displayed in the cell(s) in the steps 902 and 903 is stored as the access privilege mapping information 25. Firstly, the virtual table name and the DBMS user name corresponding to the cell for which the circle is designated on the picture are acquired. By consulting the DBMS user information 310 under the select condition of the DBMS user name acquired from the picture, the value of DBMS_UID can be obtained. Accordingly, a set of thus acquired DBMS_UID values is stored in the access privilege mapping information 25.

Referring now to FIG. 10, the process flow in the matching check 12 in the access privilege mapping during definition will be described.

In step 1001, the user names on the integration-target DBMS side are confirmed. For implementation of this confirmation, the user names and the passwords stored in the DBMS user information 310 are used to actually perform the connection processing to the respective DBMSs. When there is the user name(s) and/or the password(s) failing to be connected, the corresponding DBMS_UID is held on the memory.

In step 1002, a matching condition used to confirm the matching in the access privilege mapping 25 is derived from the virtual table definition 22 and the virtual table access privilege 24. In the following, a method of deriving the matching condition will be described. To derive the matching condition, necessary operating rights are derived in a unit of real table from the virtual table-table definition 340 and the virtual table access privilege 24 of FIG. 3. For example, it is assumed that the virtual table VT1 is defined by SQL stating “SELECT RT1_1.C1, RT1_1.C2, RT2_1.C3, RT2_1.C4 FROM RT1_1, RT2_1 WHERE RT1_1.C1=RT2_1.C1”. Here, RT1_1 and RT2_1 are the real tables on the DBMS1 (40) and the DBMS2 (50), respectively. As shown in the virtual table access privilege 24 of FIG. 3, the SELECT and UPDATE rights are given to the virtual table VT1. It will be seen that for the sake of giving the SELECT and UPDATE rights to the virtual table VT1, the real tables RT1_1 and RT2_1 actually constituting the VT1 need to have the SELECT and UPDATE rights.

Next, it will be seen that in the VT1, DB1_User1 is designated correspondingly as the user of the DBMS1 and DB1_User2 is designated correspondingly as the user of the DBMS2.

It can be derived that in order for the matching to stand between the definition DB 20 and the access privilege definition information (DBMS1 access privilege 41 and DBMS2 access privilege 51) on the individual integration-target DBMSs on the basis of the above connection, the following conditions must stand. (Matching condition 1):DB1_User1 has the SELECT right and the UPDATE right for RT1_1. (Matching condition 2):DB2_User1 has the SELECT right and the UPDATE right for RT2_1.

The deriving procedure of the matching conditions described as above is carried out as a processing in the step 1002.

In step 1003, the DBMS access privileges 41 and 45 are acquired from the integration-target DBMSs. By using the user name and the password defined DBMS by DBMS, the connection to the integration-target DBMSs is carried out. Then, the access privileges corresponding to the individual users are acquired from the DBMS1 access privilege 41 and the DBMS2 access privilege 51. As a substitutive idea for the present step, an implementing method can be used in which a super-user (a privileged user having the ability to refer all of management information for necessary DBMSs in the present embodiment) is provided for the purpose of acquiring the DBMS access privileges 41 and 51 from the integration-target DBMSs.

In step 1004, the matching validity conditions are collated with the access privileges acquired from the integration-target DBMSs to make a decision as to whether or not the matching stands. For example, it is now assumed that the DB1_User1 on the DBMS1 is granted the SELECT and UPDATE rights to the RT1_1 and the DB2_User1 is granted only the SELECT right to the RT2_1. In that case, since the DB2_User1 on the DBMS2 is not granted the UPDATE right to the RT2_1, the matching condition 2 in the step 1002 does not stand. Accordingly, the occurrence of the mismatch is determined. In the present step, only when all of the matching conditions in the step 1002 are satisfied, it is determined that the matching stands. If the matching condition contains the user name determined not to exist on the DBMS in the step 1001, the occurrence of the mismatch is determined at that time.

In step 1005, a picture is displayed in a form that can distinguish a correction-target portion where the mismatch occurs, from portions outside the correction-target portion. For example, as shown at cell 1404 in FIG. 14, the picture control such as “a cell at a portion where mapping between VT1 and DB2_User1 is given is displayed emphatically” is carried out.

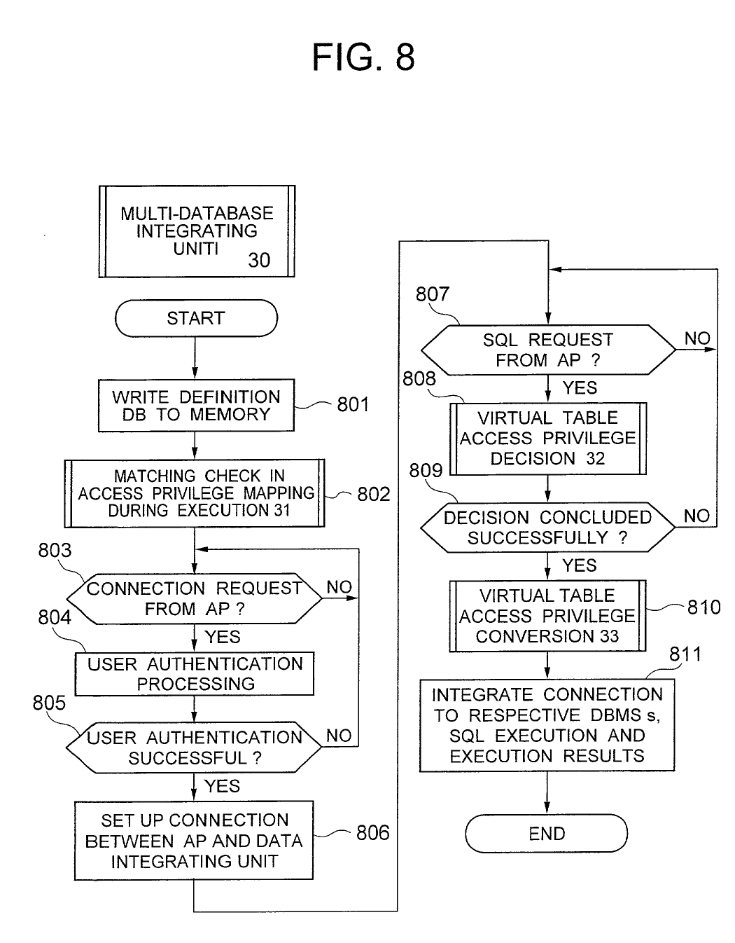

Referring now to FIG. 8, the process flow in the multi-database integrating unit 30 will be described.

In step 801, a processing for writing the information of the definition DB 20 to the memory is carried out.

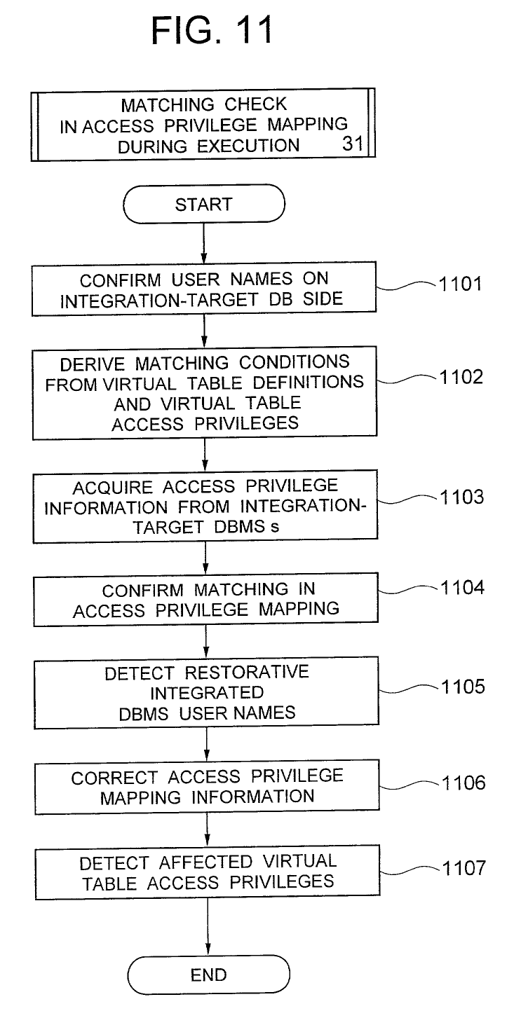

In step 802, the matching check 31 in the access privilege mapping during execution is performed. In the present processing, the access privilege mapping information on the memory is compared with an environment during execution to detect whether or not any mismatching takes place. In the event of the occurrence of the mismatch, the access privilege mapping information on the memory is corrected automatically. Details will be described later with reference to FIG. 11.

In step 803, a connection request from the AP is awaited. When the connection request from the AP is made, step 804 is executed.

In the step 804, a user authentication processing is carried out. A user authentication is determined depending on whether or not the user name and the password during the connection request from the AP exists in the user information 23. Only when a record exists which coincide in both the values of the user name and the password, the user authentication is determined to be valid.

In step 805, it is decided whether or not the user authentication is successful. If successful, step 806 is executed. If unsuccessful, the connection between the AP 60 and the multi-database integrating unit 30 is not set up, and the program returns to the step 803.

In step 806, the connection between the AP 60 and the multi-database integrating unit 30 is established in a way similar to that in the conventional DBMS.

In step 807, a SQL request from the AP 60 in the established connection is awaited. In the presence of the SQL request, step 808 is executed.

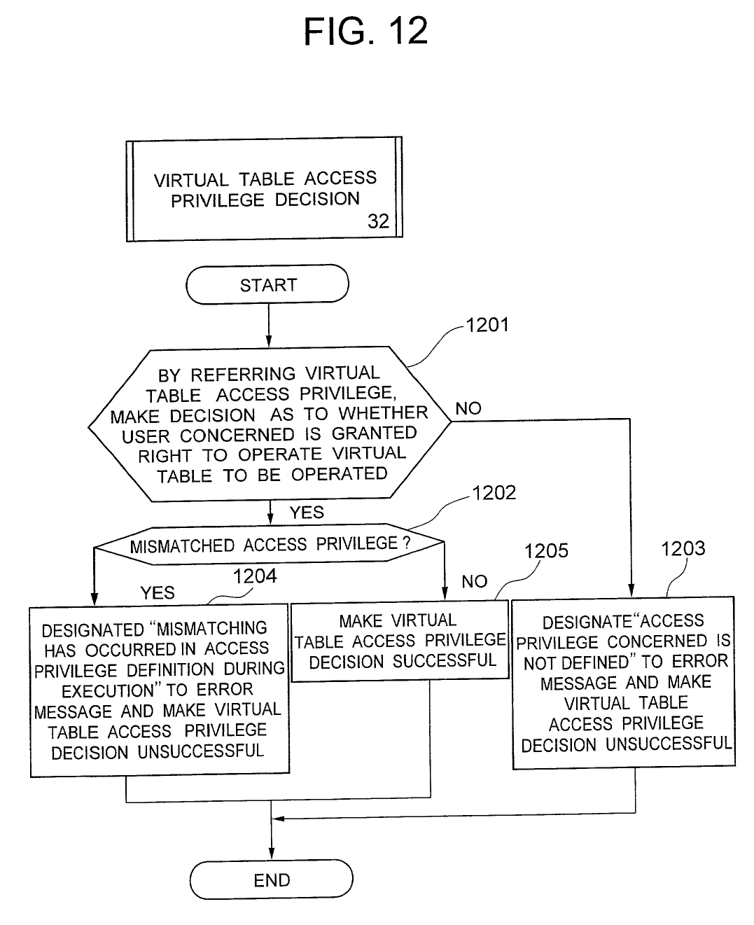

In the step 808, a processing of the virtual table access privilege decision 32 is carried out. In this step, it is decided whether or not the user connected to the multi-database integrating unit 30 is granted the virtual table requested by SQL and the operating right for the virtual table. Details will be described later with reference to FIG. 12.

In step 809, it is decided whether or not the virtual table access privilege is determined successfully. If successful, step 810 is executed. If unsuccessful, an error message is delivered and the program returns to the step 807 in which the SQL request is awaited.

In the step 810, the virtual table access privilege conversion process 33 is carried out. Here, by using the virtual table name requested by the SQL as the select condition, DBMS_UID 404 is acquired from the access privilege mapping 25. Then, DBMS connection user name 311 and the password 314 corresponding to the DBMS_UID 404 are acquired from the DBMS user information 310.

In step 811, by using the integration-target DBMS connection user names and the passwords obtained through the above steps, the connection between the integration-target DBMS side and the multi-database integrating unit 30 is established. Then, the SQL is executed in a unit of integration-target DBMS, the execution results are integrated in the multi-database integrating unit 30, and the integration result is returned to the AP 60. For the processing in the present step, the data integration processing in the prior art multi-database integrating system is used.

Referring to FIG. 11, the process flow in the matching check 31 in the access privilege mapping during execution will be described.

In step 1101, the user names on the side of the integration-target DBMSs are confirmed similarly to the step 1001 of FIG. 10.

In step 1102, a processing similar to that in the step 1002 of FIG. 10 is carried out. Matching conditions for confirming the matching are derived from the virtual table definition and the virtual table access privilege.

In step 1103, a processing similar to that of the step 1003 in FIG. 10 is carried out. Access privilege information 41 and 51 for the real tables are acquired from the integration-target DBMSs.

In step 1104, a processing similar to that in the step 1004 of FIG. 10 is carried out. By collating the matching validity conditions with the access privileges acquired from the integration-target DBMSs, it is decided whether or not the matching stands. When the example of the virtual table VT1 used in FIG. 10 is again used, the DB2_User1 on the DBMS2 is not granted the UPDATE right for RT2_1 and the conditions for validating matching do not stand, so that the occurrence of the mismatch is determined. In this condition, SQL of UPDATE cannot be executed for the virtual table VT1.

In step 1105, it is detected whether or not a user name for restoring that is utilizable in the event of the occurrence of the mismatch in place of the connection DB user name originally defined exists on the integration-target DBMS side. In the present step, the restoring user name is detected from the DB connection user name 313 on the DBMS user information 310. In the example of the virtual table VT1, if excepting the DB2_User1 another user having the SELECT right and the UPDATE right for the RT2_1 on the DBMS2 exists, then SELECT/UPDATE processing can be executed for the VT1. In the following, this type of user is called a “restoring user name”. For detection of the restoring user name, the DBMS access privileges on the individual DBMSs are referred through a processing similar to that in the step 1003 of FIG. 10. Then, it is decided whether or not the user on the DBMS has the table operating right required for the restoring user. In the case of this example, it is decided whether or not the user having the SELECT right and the UPDATE right for the RT2_1 on the DBMS2 exists on the DBMS access privilege 51. If existence is determined through the above processing, the restoring user name is detectable. When the restoring name is detected, DBMS_UID 311 corresponding to the restoring user name is acquired by referring to the DBMS user information 310. Depending on the setting contents of the DBMS user information 310 and the DBMS access privileges 41 and 51, the restoring user name cannot sometimes be detected.

In step 1106, the access privilege mapping information 25 is restored on the basis of the different user name detected in the step 1105. In case the acquisition of the restorative user name is successful, the DBMS_UID 404 in the access privilege mapping information 25 corresponding to the user name suffering from the occurrence of the mismatching is changed to DBMS_UID corresponding to the restorative user name. In this phase, a processing for delivering the log information purporting that the change is effected is carried out.

In step 1107, the virtual table access privileges affected by the absence of the restorative user name are detected from the virtual table access privilege 24. Firstly, a virtual table name 402 made to correspond to a value of DBMS_UID corresponding to an unrestorable DBMS connection user name is acquired from the access privilege mapping 25. Then, by using the acquired virtual table name as the select condition, VA_ID 361 corresponding to the affected virtual table name is obtained from the virtual table access privilege 24 and held on the memory.

Referring now to FIG. 12, the process flow in the virtual table access privilege decision 32 will be described.

In step 1201, by comparing the virtual table name and the table operating right type contained in the SQL inquired by the AP 60 with the virtual table access privilege 24, a decision as to whether or not the virtual table access privilege stands is made. If valid, step 1202 is executed. If invalid, step 1203 is executed.

In the step 1202, it is decided whether or not the VA_ID 361 on the virtual table access privilege 24 used for deciding the validity of the access privilege in the step 1201 coincides with the VA_ID 361 so detected as to be affected by the mismatch during execution in the step 1107. If the coincidence takes place for only one, step 1204 is executed. If any coincidences do not take place for all, step 1205 is executed.

In the step 1203, “The access privilege concerned is not defined” is designated to an error message, and the program is returned after determining the unsuccessful virtual table access privilege decision. The error message is informed to the AP 60 by, for example, delivering its output picture to the AP 60.

In the step 1204, “A mismatch takes place in the access privilege definition during execution” is designated to an error message, and then the program is returned after determining an unsuccessful virtual table access privilege decision. The error message is informed to the AP 60 by, for example, delivering its output picture to the AP 60.

In the step 1205, a successful virtual table access privilege decision is determined, and then the program is returned.

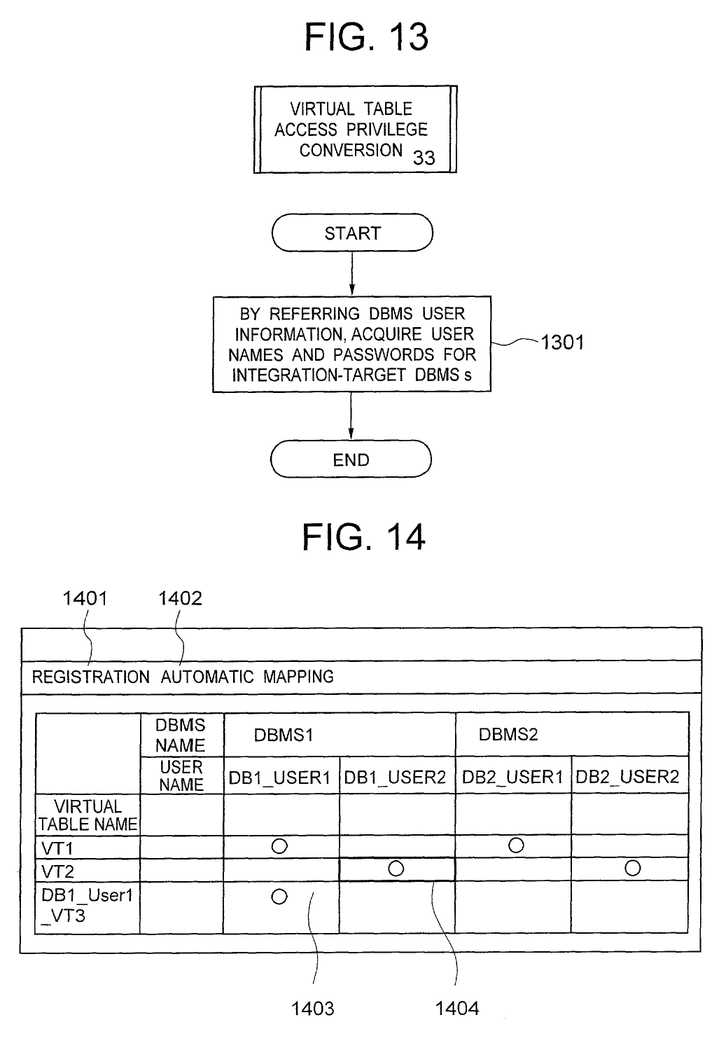

Referring to FIG. 13, the process flow in the virtual table access privilege conversion 33 will be described.

In step 1301, the user names and the passwords for the integration-target DBMSs are acquired by referring to the access privilege mapping 25 of FIG. 4 and the DBMS user information 310 of FIG. 3. In case the SQL operation is applied to the virtual table VT1, “1” and “2” are acquired as the values of DBMS_UID by referring to the access privilege mapping 25. Then, DB1_User1 and DB2_User2 can be acquired as the DB connecting user names by selecting the record information corresponding to “1” and “2” from the DBMS user information 310.

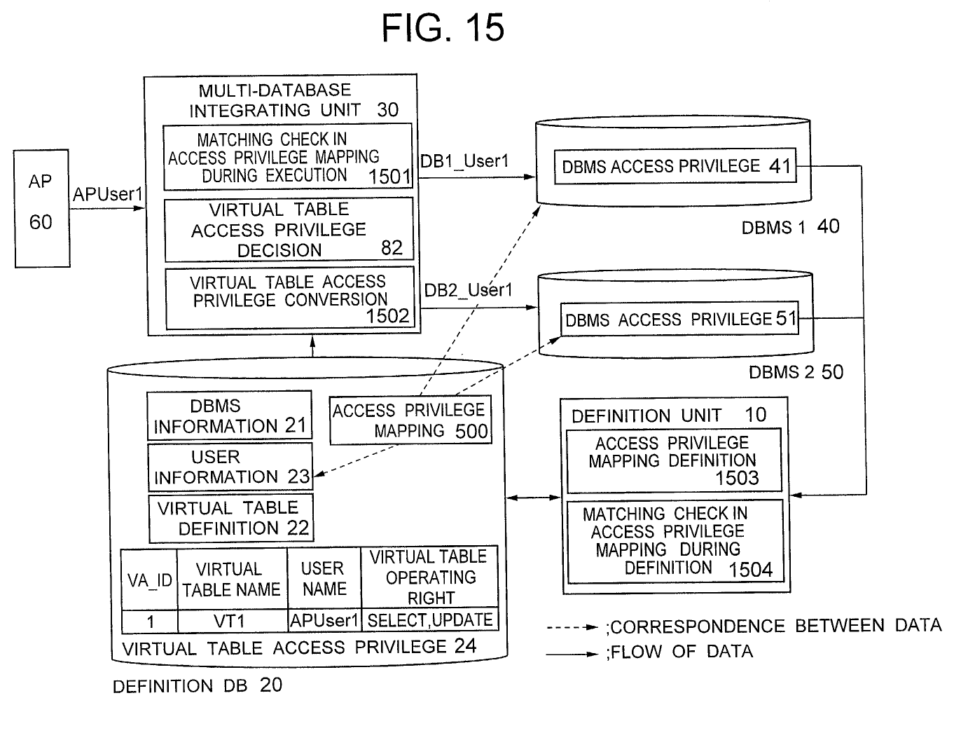

The first embodiment has been described, and the second embodiment will now be described. A processing block diagram of the second embodiment is shown in FIG. 15. In the following, differences from the first embodiment will be explained. Thus, the process flow in the second embodiment will be described from the standpoint of describing the differences from the first embodiment.

Definition DB 20 in the second embodiment differs from that in the first embodiment in that access privilege mapping information 500 detailed in FIG. 5 is used in place of the access privilege mapping information 25 in the first embodiment. As shown in the second embodiment, the user name is made to correspond to the user names of the integration-target DBMSs, as shown in FIG. 5.

Access privilege mapping definition 1503 in the second embodiment differs from the access privilege mapping definition 11 (FIG. 9) in the following points.

In the step 901 of FIG. 9, instead of displaying the list of the virtual table names and the list of the user names on the integration-target DBMS side on the screen, a list of the user names in the multi-database integrating system and a list of the use names on the integration-target DBMS side are displayed on the screen. The list of the user names in the multi-database integrating system can be acquired from the user information 22. In the steps 902 and 903, instead of defining the mapping between the virtual table names and the integration-target DBMSs, the mapping between the list of the user names in the multi-database integrating system and the user names on the integration-target DBMS side is defined. Especially, in the step 902, the user names in the multi-database integrating system are compared with the user names on the integration-target DBMS side. When coincident, the mapping processing is executed automatically. In the step 904, a storing processing for the access privilege mapping information 500 in the second embodiment is carried out.

In matching check 1504 in the access privilege mapping during definition in the second embodiment, only the confirmation of the user names on the integration-target DBMS side in the step 101 of FIG. 10 is carried out, and other steps are not conducted.

In matching check 1501 in the access privilege mapping during execution in the second embodiment, only the steps 1101 and 1107 of FIG. 11 are executed. After the integration-target DBMSs have been confirmed in the step 1101, the access privilege mapping information 500 affected by the integration-target DBMSs unconfirmed in the step 1107 is detected.

Virtual table access privilege decision 32 in the second embodiment is performed similarly to that in the first embodiment.

Access privilege conversion 1502 in the second embodiment differs from that in the first embodiment in that in place of the access privilege mapping information 25 referred by the virtual table access privilege conversion 33 in the first embodiment, the access privilege mapping information 500 is used. In the second embodiment, DBMS_UID is acquired on the basis of not the virtual table names but the user names.

As a special case in the first and second embodiments, a scheme shown in FIG. 6 can be considered. In this scheme, the connection of the fixed user names is made in a unit of DBMS, and the fixed user names “DB1_lUser1” and “DB2_User1” are made to correspond to the individual integration-target DBMSs. The present embodiment is directed to the processing for always making the connection of the fixed user names in the first and second embodiments, and will not described in greater detail.

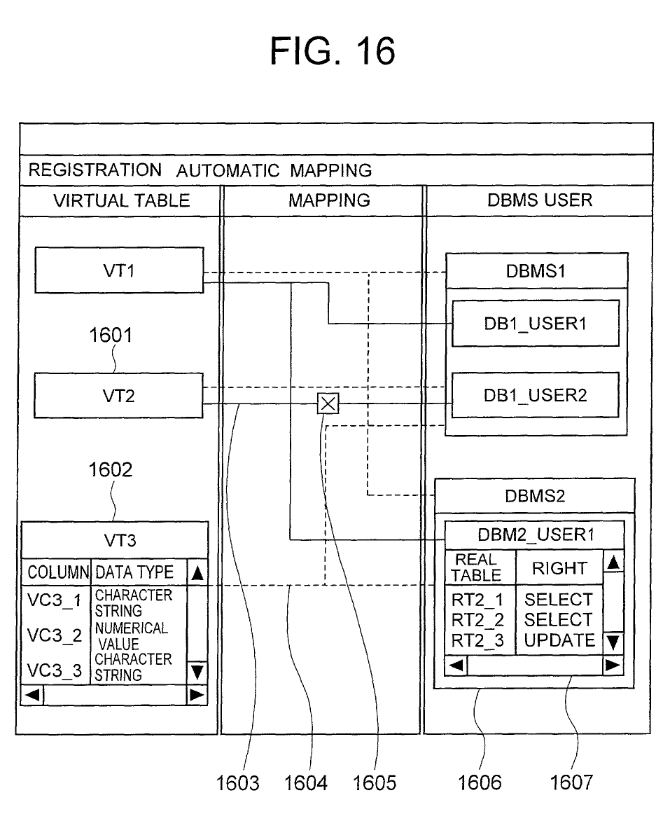

FIG. 16 shows an example of a picture for making the connection of the access privileges. In the picture example, the definition reference comparable to the picture that has already been described in connection with FIG. 14 is carried out. The virtual tables and the user names on the DB side are displayed in the form of icons on the right and left sides, respectively. When each icon is doubly clicked, the detailed contents are displayed (1602, 1607). By making the connection between the icon of the virtual table and the icon of the user name by means of the mouse, a line is drawn between the icons to indicate the linkage relation. When the error check is conducted, a line on which an error takes place is displayed in a different form from that of other lines. In FIG. 16, sign “X” is displayed (1605). An error generating line can be displayed in a way different from that described in connection with FIG. 16, for example, by changing the thickness of the line or the color thereof.

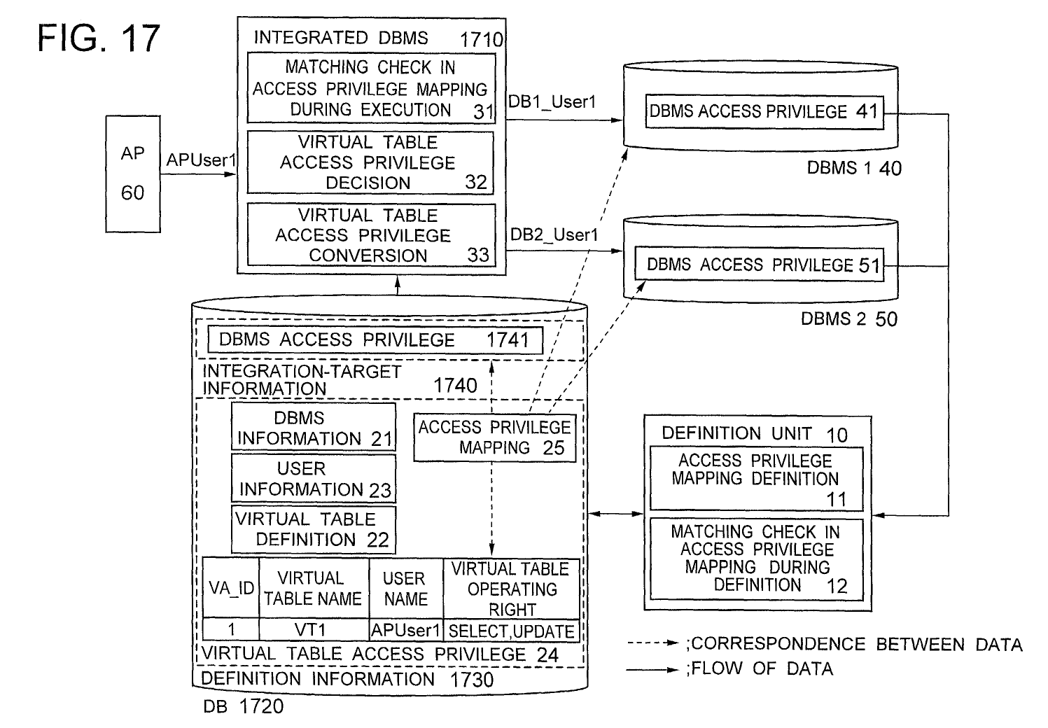

FIG. 17 shows another embodiment of the invention which uses an integrating DBMS 1710 for integrating the DBMS of its own and other DBMSs. In the present embodiment, the control of the virtual table access privileges is practiced as the extension function that has already been present on the DBMS. In the present embodiment, the integration of the tables of the integrating DBMS 1710 with the tables of, for example, an external DBMS1 40 is defined as the virtual table. Then, similarly to the embodiments already set forth so far, the access privilege mapping definition 11 using the DBMS access privilege 1741 for the integrating DBMS 1710 and the DBMS access privilege 41 for the external DBMS1 (40) is carried out. By using the definition information 1730 defined in the above process, a series of processing such as virtual table access privilege decision 32 and virtual table access privilege conversion 33 are carried out for the virtual table integrating the tables of the integrating DBMS 1710 with the tables of the external DBMS1 (40), by means of the integrating DBMS 1710. The information stored in the definition information 1730 is similar to the definition DB 20 that has already been described, and will not be detailed. The access privilege mapping 25 is shown in FIG. 17. But, the connection made by the access privilege mapping as described in connection with the foregoing embodiments can also be carried out by means of the integrating DBMS 1710.

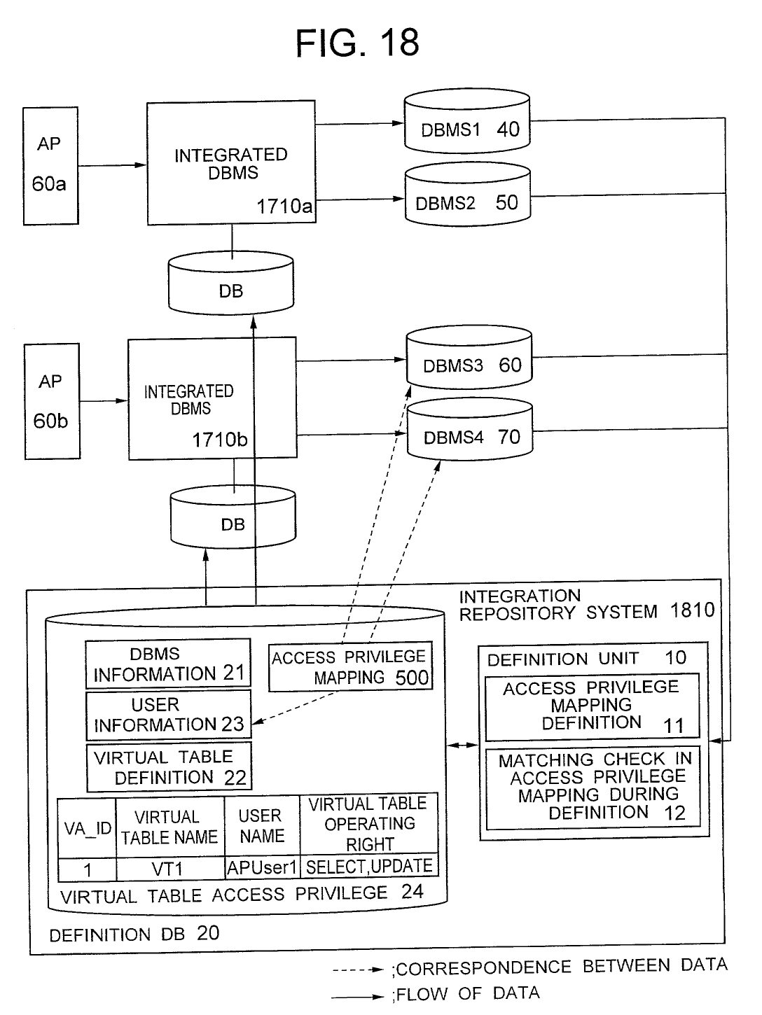

FIG. 18 is a system construction diagram in case the definition tools manage a plurality of the DB integrating system. In FIG. 18, the contents of the definition DB manage the integration of the definition information of the individual sub-systems. In other words, FIG. 18 shows another embodiment which is directed to an integrating repository system. The integrating repository system referred to herein is a system for managing the setting information such as access privileges and data arrangements (called meta-data) existing over systems for linking the middle wares such as DBMS, document management and EDI.

In the present embodiment, the definition unit 10 for the virtual table access privilege is realized as one function of the integrating repository system 1810. The setting information (meta-data) defined by the integrating repository system 1810 is distributed from the definition DB 20 to the middle ware serving as a linkage object. In FIG. 18, an instance where meta-data is distributed from the definition DB 20 to the integrating DBMSs 1710a and 1710b is shown. Then, each of the integrating DBMSs 1710a and 1710b performs by itself a series of processing such as virtual table access privilege decision 32 and virtual table access privilege conversion 33 on the basis of the distributed meta-data.

Through the foregoing embodiments, the access privilege definition for the virtual tables on the AP side and the access privilege definition on the integration-target side can be subjected to the system structuring process in parallel. With the present scheme, the user setting necessary to acquire, on the integration-target DBMS side, the virtual tables representing the accessing objects and the log information for separating the users accessing the virtual tables can be facilitated on the integration-target DBMS side.

1. A multi-database system in which a plurality of database apparatuses each storing data, a multi-database processing apparatus for performing an integration processing to the data stored in said plurality of database apparatuses, and a user processing apparatus for receiving the integration-processed data from said multi-database processing apparatus are connected mutually through a network, wherein
each of said plurality of database apparatuses includes:
means for storing dispersed data; and
means for storing a dispersed-data access privilege, said dispersed-data access privilege being an access privilege to the dispersed data, and making connection with dispersed-data identification information for identifying a user or user processing apparatus permitted to access the dispersed data and a dispersed-data operating right indicative of operation contents by which the user or the user processing apparatus indicated by said dispersed-data identification information are permitted to operate the dispersed data, and
said multi-database processing apparatus includes:
means for receiving a plurality of the dispersed data from said plurality of database apparatuses;
means for integrating said plurality of received dispersed data to generate integrated data;
means for storing an integrated-data access privilege, said integrated-data access privilege being an access privilege to the integrated data, and making connection with integrated-data identification information for identifying a user or user processing apparatus permitted to access the integrated data and an integrated-data operating right indicative of operation contents by which the user or user processing apparatus indicated by said integrated-data identification information are permitted to operate the integrated data;
means for receiving an access request, said access request being an access request for operating the integrated data from said user processing apparatus, and containing user identification information for identifying a user of the user processing apparatus concerned or the user processing apparatus concerned; and
means for controlling operation indicated by said access request and respectively applied to said plurality of dispersed data constituting the integrated data by using said dispersed-data access privilege and said integrated-data access privilege.

2. A multi-database system according to claim 1, wherein the operation contents indicated by said dispersed-data operating rights includes at least one of insert, select, change, and copy of the dispersed data.

3. A multi-database system according to claim 2, wherein the change of the dispersed data includes at least one of update, substitute, and delete of the dispersed data and addition of data to the dispersed data.

4. A multi-database system according to claim 1, wherein the operation contents indicated by said integrated-data operating rights includes at least one of insert, select, change, and copy of the integrated data.

5. A multi-database system according to claim 4, wherein the change of the integrated data includes at least one of update, substitute, and delete of the integrated data and addition of data to the integrated data.

6. A multi-database system according to claim 1, wherein when operation indicated by said access request is operation applied to dispersed data which the user or user processing apparatus identified by said user identification information is inhibited from operating, said controlling means limits the operation indicated by said access request.

7. A multi-database system according to claim 6, wherein when the operation indicated by said access request is operation which the user or user processing apparatus identified by said user identification information is either inhibited from or permitted for operating by said integrated-data access privileges, said controlling means limits the operation indicated by said access request.

8. A multi-database system according to claim 6, wherein
the limit operation by said controlling means is to inhibit the operation; and
said controlling means controls permission/inhibition of the operation indicated by said access requests and respectively applied to said plurality of dispersed data constituting the integrated data, by using said dispersed-data access privilege and said integrated-data access privilege.

9. A multi-database processing system connected to a plurality of database apparatuses each storing data, and a plurality of user apparatuses, and for integrating the data stored in said plurality of database apparatuses, comprising:
means for receiving a plurality of dispersed data from said plurality of database apparatuses;
means for receiving a dispersed-data access privilege from each of said plurality of database apparatuses, said dispersed-data access privilege being an access privilege to the dispersed data, and making connection with dispersed-data identification information for identifying a user or user processing apparatus permitted to access the dispersed data and a dispersed-data operating right indicative of operation contents by which the user or user processing apparatus indicated by said dispersed-data identification information are permitted to operate the dispersed data;
means for performing an integration processing to a plurality of received dispersed data to generate integrated data;
means for storing an integrated-data access privilege, said integrated-data access privilege making the connection with integrated-data identification information for identifying a user or user processing apparatus permitted to access the integrated data and an integrated-data operating right indicative of operation contents by which the user or user processing apparatus indicated by said integrated-data identification information are permitted to operate the integrated data;
means for receiving an access request from said user processing apparatus, said access request being an access request for operating said integrated data, and containing user identification information for identifying a user of the user processing apparatus concerned or the user processing apparatus concerned; and
means for controlling operation indicated by said access request and respectively applied to said plurality of dispersed data constituting the integrated data, by using said dispersed-data access privilege and said integrated-data access privilege.

10. A multi-database processing system according to claim 9, wherein the operation contents indicated by said dispersed-data operating right includes at least one of insert, select, change, and copy of the dispersed data.

11. A multi-database processing system according to claim 10, wherein the change of the dispersed data includes at least one of update, substitute, and delete of the dispersed data and addition of data to the dispersed data.

12. A multi-database processing system according to claim 9, wherein the operation contents indicated by said integrated-data operating right includes at least one of insert, select, change, and copy of the integrated data.

13. A multi-database processing system according to claim 12, wherein the change of the integrated data includes at least one of update, substitute, and delete of the integrated data and addition of data to the dispersed data.

14. A multi-database processing system according to claim 9, wherein when operation indicated by said access request is operation applied to dispersed data which the user or user processing apparatus indicated by said user identification information is inhibited from operating by said dispersed-data access privilege, said controlling means limits the operation indicated by said access request.

15. A multi-database processing system according to claim 14, wherein the limit operation by said controlling means is to inhibit the operation.

16. A multi-database processing system according to claim 14, wherein when the operation indicated by said access request is operation which the user or user processing apparatus indicated by said user identification information is either inhibited from or permitted for operating by said integrated-data access privilege, said controlling means limits the operation indicated by said access request.

17. A multi-database processing system according claim 16, wherein the limit operation by said controlling means is to inhibit the operation.
